(19) United States
(12) Patent Application Publication
(10) Pub. No.: US 2022/0365390 A1
(43) Pub. Date: Nov. 17, 2022

(54) DISPLAY PANEL AND DISPLAY DEVICE

(71) Applicants: CHUZHOU HKC OPTOELECTRONICS TECHNOLOGY CO., LTD., Chuzhou (CN); HKC CORPORATION LIMITED, Shenzhen (CN)

(72) Inventors: Shengyao CHEN, Chuzhou (CN); Haoxuan ZHENG, Chuzhou (CN)

(73) Assignees: CHUZHOU HKC OPTOELECTRONICS TECHNOLOGY CO., LTD., Chuzhou (CN); HKC CORPORATION LIMITED, Shenzhen (CN)

(21) Appl. No.: 17/875,842

(22) Filed: Jul. 28, 2022

Related U.S. Application Data
(63) Continuation of application No. PCT/CN2021/142643, filed on Dec. 29, 2021.

(30) Foreign Application Priority Data
Apr. 30, 2021 (CN) 202110492832.X

(51) Int. Cl. G02F 1/1335; G02F 1/1339

(52) U.S. Cl. CPC G02F 1/133514; G02F 1/13394

(57) ABSTRACT

A display panel and a display device including the display panel are disclosed. The display panel includes an array substrate, a color film substrate, and a liquid crystal layer and a first spacer both between the array substrate and the color film substrate. Assembly surfaces of the color film substrate and the array substrate are oppositely assembled. An edge of the assembly surface of the color film substrate is provided with an edge shielding area. An edge of the assembly surface of the array substrate is provided with a component located in a projection of the edge shielding area on the array substrate. The first spacer is located in the edge shielding area and outside the projection of the component on the edge shielding area. The first spacer supports the edge shielding area and an area of the array substrate corresponding to the edge shielding area.

### CROSS-REFERENCE TO RELATED APPLICATIONS

This application is a continuation of International Application No. PCT/CN2021/142643, filed on Dec. 29, 2021, which claims priority to Chinese Patent Application No. 202110492832.X, filed on Apr. 30, 2021. The disclosures of the aforementioned applications are incorporated in this application by reference in their entirety.

### TECHNICAL FIELD

The present application relates to the field of display technology, and in particular, to a display panel and a display device.

### BACKGROUND

The display panels with narrow frames or without frames are the development directions of the liquid crystal display industry. In the related art, for the display panel without planarizing layers on the edges, when the array substrate and the color film substrate are assembled, the components on the edge of the array substrate are overlapped with the spacers on the edge of the color film substrate, and the edge of the array substrate and the edge the color film substrate are supported by the overlapped spacers and components, which is easy to cause the edge of the display panel to be bright or dark, and the visual sense of the dark state test is affected.

### SUMMARY

The main purpose of the present application is to provide a display panel and a display device, which aims to solve the technical problem in the prior art that the edge of the display panel is bright or dark due to the overlapping arrangement of the component on the edge of the array substrate and the first spacer on the edge of the color film substrate.

In order to achieve the above purpose, the display panel provided by the present application includes:

an array substrate having a component provided at an edge of an assembly surface thereof;

a color film substrate with an assembly surface facing the assembly surface of the array substrate and assembled with the assembly surface of the array substrate, an edge of the assembly surface of the color film substrate being provided with an edge shielding area, and the component being located in a projection of the edge shielding area on the array substrate;

a liquid crystal layer sandwiched between the array substrate and the color film substrate; and

a first spacer disposed between the array substrate and the color filter substrate and within the edge shielding area, the first spacer being located outside a projection of the component on the edge shielding area, and the first spacer supporting the edge shielding area and an area of the array substrate corresponding to the edge shielding area.

In an embodiment, the component is an electrically conductive element and insulated from the edge shielding area.

In an embodiment, an insulating spacer is provided between the component and the edge shielding area for insulating the component from the edge shielding area, the component and the edge shielding area are insulated and assembled by the insulating spacer, and a thickness of the insulating spacer is less than or equal to a distance from a side of the component towards the edge shielding area.

In an embodiment, the assembly surface of the color filter substrate is provided with a color resist area laid with a color resist, and the insulating spacer and the color resist are same in material and size.

In an embodiment, a plurality of insulating spacers are laid at intervals in the projection of the edge shielding area.

In an embodiment, the assembly surface of the color filter substrate is provided with a color resist area laid with a plurality of color resists, and a color resist shielding area is provided between two adjacent color resists.

In an embodiment, the display panel further includes a second spacer disposed between the array substrate and the color filter substrate and within the color resist shielding area, and the second spacer supports the color resist shielding area and an area of the array substrate corresponding to the color resist shielding area.

In an embodiment, first spacers are distributed on two opposite sides of the projection of the component on the edge shielding area.

In an embodiment, the first spacers are symmetrically arranged on the two opposite sides of the projection of the component on the edge shielding area.

The display device provided by the present application includes the above display panel and a support member, and the display panel is assembled on the support member.

In the embodiments of the present application, the first spacer is disposed outside the projection of the component projected on the edge shielding area, and is away from the component. The first spacer directly supports the edge shielding area and the area of the array substrate corresponding to the edge shielding area, thereby the distance between the edge of the color film substrate and the edge of the array substrate is easily to be controlled, and the problem that the edge of the display panel is bright or dark due to the tall or short total height of the overlapped spacer and component is avoided. The edge of the color film substrate has an edge shielding area to avoid light leakage at the edge of the display panel. The first spacer is provided in the edge shielding area, which can avoid the influence of the first spacer on a display area of the display panel. The solution proposed by the present application has no light leakage and is no bright or dark at the edge, and has good edge dark state effect.

### BRIEF DESCRIPTION OF THE DRAWINGS

In order to more clearly explain the embodiments of the present application or the technical solutions in the related art, the drawings used in the description of the embodiments or the related art will be briefly introduced below. Obviously, the drawings in the following description are merely some embodiments of the present application. For those of ordinary skill in the art, other drawings can be obtained based on the structure shown in these drawings without creative work.

FIG. 1 is a schematic cross-sectional view of an embodiment of a display panel according to the present application.

FIG. 2 is a distribution diagram of components on an assembly surface of a color film substrate according to an embodiment of the display panel of the present application.

FIG. 3 is a schematic structural diagram of a display device of the present application.

The realization of the purposes, functional features and advantages of the present application will be further explained with reference to the accompanying drawings in combination with the embodiments.

### DETAILED DESCRIPTION OF THE EMBODIMENTS

In the following, the embodiments of the present application will be clearly and completely described with reference to the drawings in the embodiments of the present application. Obviously, the described embodiments are only some of the embodiments of the present application, and not all of the embodiments. Based on the embodiments of the present application, all other embodiments obtained by those of ordinary skilled in the art without creative efforts shall fall within the claimed scope of the present application.

It should be noted that all directional indicators (such as up, down, left, right, front, back, etc.) in the embodiments of the present application are only used to explain the relative positional relationship, movement situation, etc. between components in a specific attitude (as shown in the drawings). If the specific attitude changes, the directional indication also changes accordingly.

In the present application, unless expressly specified defined otherwise, the terms “connected,” “fixed,” etc. should be understood broadly, for example, “fixed” may be a fixed connection or a detachable connection, or may be a mechanical connection or an electrical connection; or may be a direct connection or an indirect connection through an intermediate medium, or may be a connection insides two elements or an interaction relationship between the two elements, unless explicitly defined otherwise. For those skilled in the art, the specific meanings of the above terms in the present application may be understood according to specific situations.

In addition, the descriptions related to “first,” “second” and the like in the present application are for descriptive purposes only, and should not be understood as indicating or implying their relative importance or implicitly indicating the number of technical features indicated. Therefore, a feature defined by “first” and “second” may explicitly or implicitly include at least one of such feature. In addition, the meaning of “and/or” in the full text includes three parallel solutions, taking “A and/or B” as an example, it includes solution A, solution B, or both solutions A and B. The various embodiments can be combined with each other, but the combination must be based on what can be achieved by those of ordinary skill in the art. When the combination of the embodiments is contradictory or cannot be achieved, it should be considered that such a combination does not exist, or is not within the scope of the claims of the present application.

The present application provides a display panel and a display device. The display panel has no light leakage at the edge, is not bright or dark at the edge, and has a good dark state effect at the edge.

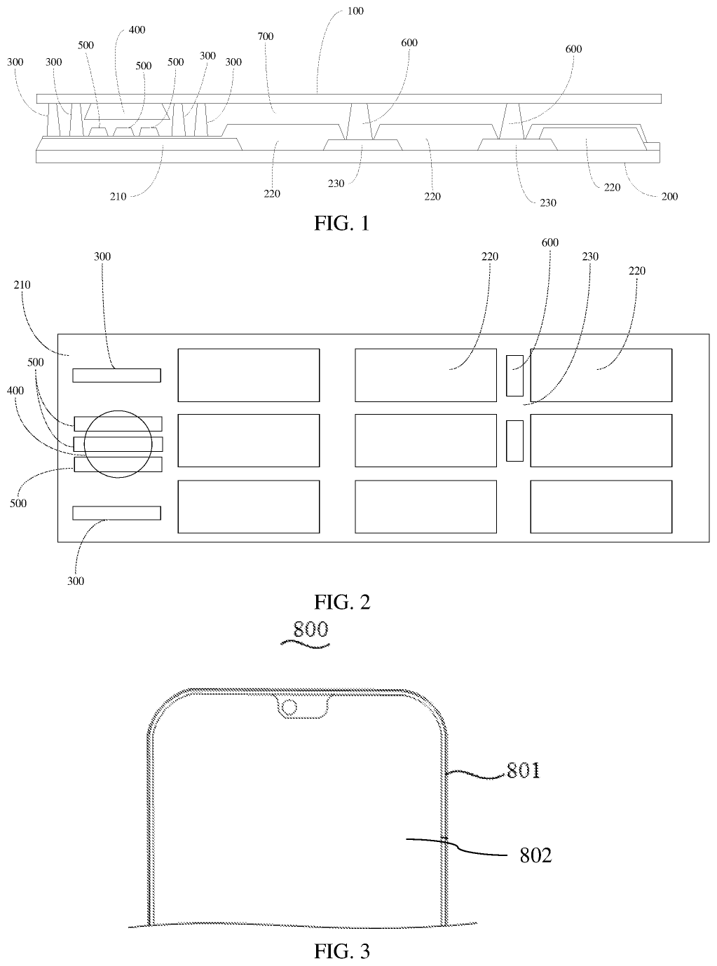

As shown in FIG. 1, in an embodiment of the display panel provided in the present application, the display panel includes an array substrate 100, a color filter substrate 200, a liquid crystal layer 700, and a first spacer 300. A component 400 is provided at an edge of an assembly surface of the array substrate 100. An assembly surface of the color film substrate 200 faces the assembly surface of the array substrate 100 directly and is assembled with the assembly surface of the array substrate 100. An edge of the assembly surface of the color film substrate 200 has an edge shielding area 210, and the component 400 is in a projection range of the edge shielding area 210 on the array substrate 100. The liquid crystal layer 700 is sandwiched between array substrate 100 and color film substrate 200. The first spacer 300 is arranged between the array substrate 100 and the color film substrate 200, and located in the edge shielding area 210. The first spacer 300 is outside a projection area of the component 400 on the edge shielding area 210, and the first spacer 300 is located in the edge shielding area 210 away from the component 400. The first spacer 300 supports the edge shielding area 210 and an area of the array substrate 100 corresponding to the edge shielding area 210, to make the distance between the edges of the assembled array substrate 100 and color film substrate 200 constant.

The assembly surface of the array substrate 100 refers to a surface of the array substrate 100 to be assembled with the color film substrate 200, and the assembly surface of the color film substrate 200 refers to a surface of the color film substrate 200 to be assembled with the array substrate 100.

In the related art, when the spacer and the component 400 are overlapped to support the edges of the array substrate 100 and the color film substrate 200, the total height of the spacer and the component 400 after overlapping is not constant, and is difficult to control. The tall or short total height of the overlapped spacer and component 400 will cause the array substrate 100 to be convex or concave at positions where the spacer or the component 400 is located.

As shown in FIG. 2, the first spacer 300 is disposed outside the projection of the component 400 projected on the edge shielding area 210, and is away from the component 400. The first spacer 300 directly supports the edge shielding area 210 and the area of the array substrate 100 corresponding to the edge shielding area 210, not only a supporting effect is achieved, but also the distance between the edge of the color film substrate 200 and the edge of the array substrate 100 is easily to be controlled, so that the distance between the edges of the assembled array substrate 100 and color film substrate 200 is constant, and the problem that the edge of the display panel is bright or dark due to the tall or short total height of the overlapped spacer and component 400 is avoided. The edge of the color film substrate 200 has an edge shielding area 210 to avoid light leakage at the edge of the display panel. The first spacer 300 is provided in the edge shielding area 210, which can avoid the influence of the first spacer 300 on a display area of the display panel. The solution proposed by the present application has no light leakage and is no bright or dark at the edge, and has good edge dark state effect. The above solution has no influence on the manufacturing of the display panel, and the cost is not increased.

In a further solution of the above embodiment, the component 400 is an electrically conductive element, and the component 400 and the edge shielding area 210 are insulated from each other.

In a further solution of the above embodiment, the conductive component 400 and the edge shielding area 210 are assembled and insulated from each other. Thus the component 400 can be effectively protected, contact between the component 400 and a conductive structure in the edge shielding area 210 is avoided, and accidents such as short circuit are avoided,

In a further solution of the above embodiment, an insulating spacer 500 for insulating the component 400 from the edge shielding area 210 is provided between the component 400 and the edge shielding area 210. The component 400 and the edge shielding area 210 are insulated by means of the insulating spacer 500, and a thickness of the insulating spacer 500 is less than or equal to a distance from a side of the component 400 towards the edge shielding area 210 to the edge shielding area 210.

In the further solution of the above embodiment, by providing the insulating spacer 500, the component 400 is prevented to contact with the edge shielding area 210, the effect of insulating can be achieved, and the structure is simple. For the thickness of the insulating spacer 500 is less than or equal to the distance from the side of the component 400 towards the edge shielding area 210 to the edge shielding area 210, the insulating spacer 500 does not press the component 400 to cause the array substrate 100 to protrude outwards at a position where the component 400 is located.

In an embodiment, the thickness of the insulating spacer 500 is less than the distance from the side of the component 400 towards the edge shielding area 210 to the edge shielding area 210, and there is a space between the insulating spacer 500 and the component 400, which facilitates the adjustment of the array substrate 100 and the color filter substrate 200.

In a further solution of the above embodiment, a color resist area is provided on the assembly surface of the color filter substrate 200, a color resist 220 is laid in the color resist area, and the insulating spacer 500 and the color resist 220 are the same in material and size.

In a further solution of the above embodiment, the color resist 220 is directly used as the insulating spacer 500, the material is easy to obtain, the cost is low, it is easily to make the insulating spacer 500 and the color resist 220 be the same in thickness, and the insulating spacer 500 is prevented from pressing the component 400 to cause the protrusion of a corresponding area of the array substrate 100.

In a further solution of the above embodiment, a plurality of insulating spacers 500 are located at intervals in the projection of the component 400 on the edge shielding area 210.

In the further solution of the above embodiments, the component 400 being effectively isolated from the edge shielding area 210 is ensured. When the color resist 220 is directly used as the insulating spacer 500, the color resist 220 can be directly used without further processing, the cost is low, and the process is simple. The insulating spacers being tiled at intervals can reduce the number of the color resists 220 used as the insulating spacers 500, and the thicknesses of the color resists 220 in the color resist area can be kept consistent.

The insulating spacers 500 may be strip-shaped color resists 220, and are laid at intervals and in parallel in the projection of the component 400 on the edge shielding area 210.

In a further solution of the above embodiment, the color resist area is provided on the assembly surface of the color filter substrate 200. A plurality of color resists 220 are laid in the color resist area at intervals, and a color resist shielding area 230 is provided between two adjacent color resists 220.

In the further solution of the above embodiments, there is a color resist shielding area. 230 between two adjacent color resists 220, thereby avoiding light leakage and crosstalk between the color resists 220.

In a further solution of the above embodiment, the display panel further includes a second spacer 600 disposed between the array substrate 100 and the color filter substrate 200 and within the color resist shielding area 230. The second spacer 600 supports the color resist shielding area 230 and an area of the array substrate 100 corresponding to the color resist shielding area 230.

In the further solution of the above embodiment, the second spacer 600 is provided to support the color resist shielding area 230 and an area of the array substrate 100 corresponding to the color resist shielding area 230, and the color film substrate 200 and the array substrate 100 are stably supported and the distance therebetween are not easy to change. Therefore, the display problem caused by the change of the distance between the color film substrate 200 and the array substrate 100 can be avoided. The second spacer 600 is disposed in the color resist shielding area 230, and the second spacer 600 is prevented from affecting the display of the display area of the display panel.

In a further solution of the above embodiment, first spacers 300 are also distributed on two opposite sides of the projection of the component 400 on the edge shielding area 210.

In the further solution of the above embodiment, both sides of the projection of the component 400 on the edge shielding area 210 are provided with a first spacer 300, thereby the edges of the array substrate 100 and the color film substrate 200 are more stably supported, and the display problem caused by change of the distance between the array substrate 100 and the color film substrate 200 is avoided.

In an embodiment, areas on two opposite sides of the projection of the component 400 on the edge shielding area 210 may be areas between the projection of the component 400 on the edge shielding area 210 and an outer edge of the edge shielding area 210, or be areas between the projection of the component 400 on the edge shielding area 210 and an inner edge of the edge shielding area 210.

The areas on two opposite sides of the projection of the component 400 on the edge shielding area 210 may be areas between the projection of the component 400 on the edge shielding area 210 and two opposite outer edges of the edge shielding area 210.

In a further solution of the above embodiment, the first spacers 300 are symmetrically arranged on both sides of the projection of the component 400 on the edge shielding area 210.

In the further solution of the above embodiments, the edges of the array substrate 100 and the color filter substrate 200 are more stably supported, and the display problem caused by change of the distance between the array substrate 100 and the color film substrate 200 is avoided.

A size of the first spacer 300 may be 10*10 um, and the size of the first spacer 300 is reduced relative to the 50*50 um spacer overlapped with the component 400 in the related art, thereby the first spacer 300 can be conveniently arranged in the edge shielding area 210 on both sides of the component 400. Two first spacers 300 may be arranged at intervals on each of the two sides of the projection of the component 400 on the edge shielding area 210, and the supporting effect is ensured.

The first spacer 300 may be strip-shaped and stable to support, and the first space may be arranged in parallel with the strip-shaped insulating spacer 500, which is convenient to arrange, and can prevent the first spacer 300 and the insulating spacer 500 from affecting each other.

The component 400 may include a first metal layer (M1) and a second metal layer (M2) and various traces and driving lines thereon, etc.

The color resist 220 includes a red color resist 220 (R), a green color resist 220 (G), and a blue color resist 220 (B) having the same thickness. The insulating spacer 500 can be the same as the color resist 220 of any color in material and size, and there is no need to consider the difference in color. The insulating spacer 500 may be a strip-shaped color resistor 220, and the first spacer 300 may also be strip-shaped, therefore, the first spacer 300 and the insulation spacer can be arranged in parallel.

Referring to FIG. 3, in an embodiment of a display device 800 provided in the present application, the display device 800 includes the above display panel 802 and a support member 801, and the display panel 802 is assembled on the support member.

Since the display device provided in the present application employs all the technical features of the above-mentioned display panel, the display device has at least the beneficial effects brought by the embodiments of the display panel described above which are not repeated here.

The above is only a preferred embodiment of the present application, and is not therefore limiting the scope of the present application. Any equivalent structural transformation made by using the contents of the specification and drawings of the present application or any direct or indirect application in other related technical fields under the inventive concept of the present application is included in the claimed scope of the present application.

What is claimed is:

1. A display panel, comprising:
an array substrate having a component provided at an edge of an assembly surface thereof;
a color film substrate with an assembly surface facing the assembly surface of the array substrate and assembled with the assembly surface of the array substrate, an edge of the assembly surface of the color film substrate being provided with an edge shielding area, and the component being located in a projection of the edge shielding area on the array substrate;
a liquid crystal layer sandwiched between the array substrate and the color film substrate; and
a first spacer disposed between the array substrate and the color filter substrate and within the edge shielding area, the first spacer being located outside a projection of the component on the edge shielding area, and the first spacer supporting the edge shielding area and an area of the array substrate corresponding to the edge shielding area.

2. The display panel according to claim 1, wherein the component is an electrically conductive element and insulated from the edge shielding area.

3. The display panel according to claim 2, wherein an insulating spacer is provided between the component and the edge shielding area for insulating the component from the edge shielding area, the component and the edge shielding area are insulated and assembled by the insulating spacer.

4. The display panel according to claim 3, wherein a thickness of the insulating spacer is less than or equal to a distance from a side of the component towards the edge shielding area.

5. The display panel according to claim 3, wherein the assembly surface of the color filter substrate is provided with a color resist area laid with a color resist, and the insulating spacer and the color resist are same in material and size.

6. The display panel according to claim 5, wherein a plurality of insulating spacers are laid at intervals in the projection of the edge shielding area.

7. The display panel according to claim 6, wherein the plurality of insulating spacers are strip-shaped color resists and are laid at intervals and in parallel in the projection of the component on the edge shielding area.

8. The display panel according to claim 1, wherein the assembly surface of the color filter substrate is provided with a color resist area laid with a plurality of color resists, and a color resist shielding area is provided between two adjacent color resists.

9. The display panel according to claim 8, further comprising a second spacer disposed between the array substrate and the color filter substrate and within the color resist shielding area, the second spacer supporting the color resist shielding area and an area of the array substrate corresponding to the color resist shielding area.

10. The display panel according to claim 1, wherein first spacers are distributed on two opposite sides of the projection of the component on the edge shielding area.

11. The display panel according to claim 10, wherein the first spacers are symmetrically arranged on the two opposite sides of the projection of the component on the edge shielding area.

12. The display panel according to claim 1, wherein the component comprises a first metal layer, a second metal layer and traces and driving lines on the first metal layer and the second metal layer.

13. The display panel according to claim 5, wherein the color resist comprises a red color resist, a green color resist, and a blue color resist having a same thickness, and the insulating spacer is same as a color resist of any color in material and size.

14. The display panel according to claim 3, wherein the insulating spacer and the first spacer are strip-shaped and parallel to each other.

15. A display device, comprising the display panel according to claim 1 and a support member, the display panel being assembled on the support member.
